(19) United States
(12) Patent Application Publication
(10) Pub. No.: US 2010/0332777 A1
(43) Pub. Date: Dec. 30, 2010

(54) DATA BACKUP APPARATUS AND DATA BACKUP METHOD

(76) Inventors: Pi-Hsi Tsai, Hsinchu City (TW); Chun-Hung Kuo, Hsinchu City (TW); Hsu-Ting Chien, Taichung County (TW)

Correspondence Address: NORTH AMERICA INTELLECTUAL PROPERTY CORPORATION, P.O. BOX 506, MERRIFIELD, VA, 22116, US

(21) Appl. No.: 12/626,927

(22) Filed: Nov. 29, 2009

(30) Foreign Application Priority Data
Jun. 30, 2009 (TW) 098122037

(51) Int. Cl. G06F 12/16; G06F 12/00

(52) U.S. Cl. 711/162; 711/E12.001; 711/E12.103

(57) ABSTRACT

A data backup apparatus includes a host interface, a first storage medium interface, a second storage medium interface and a controller. The host interface is utilized to be electrically connected with a host, the first storage medium interface is utilized to be electrically connected with a first storage medium, and the second storage medium interface is utilized to be electrically connected with a second storage medium. The controller is coupled to the host interface, the first storage medium interface and the second storage medium interface, and is utilized for copying data from the first storage medium to the second storage medium without passing through the host interface.

### BACKGROUND OF THE INVENTION

1. Field of the Invention

The present invention relates to a data backup apparatus, and more particularly, to a data backup apparatus which can copy data from a first storage medium to a second storage medium without passing through a host interface.

2. Description of the Prior Art

To prevent data stored in a hard disk from being lost, a user generally backs up important data from the hard disk to another storage device. For example, the user can backup the data from the hard disk to another hard disk, or to an optical disc or other storage devices. During the backup operation, the computer host first copies the data from a source hard disk to the computer host, and then copies the data from the computer host to a target hard disk. If the data amount is large, however, a great portion of the bandwidth between the hard disks and the computer host is occupied by the data, and the loading of the computer host (e.g., CPU and the memory) is also increased, further influencing the other operations of the computer host and the hard disks.

### SUMMARY OF THE INVENTION

It is therefore an objective of the present invention to provide a data backup apparatus and related data backup method, which can avoid occupying a significant portion of the bandwidth between the hard disks and the computer host during the backup operation, to solve the above-mentioned problems.

According to one embodiment of the present invention, a data backup apparatus comprises a host interface, a first storage medium interface, a second storage medium interface and a controller. The host interface is utilized to be electrically connected with a host, the first storage medium interface is utilized to be electrically connected with a first storage medium, and the second storage medium interface is utilized to be electrically connected with a second storage medium. The controller is coupled to the host interface, the first storage medium interface and the second storage medium interface, and is utilized for copying data from the first storage medium to the second storage medium without passing through the host interface.

According to one embodiment of the present invention, a data backup method comprises: providing a data backup apparatus, where the data backup apparatus includes a host interface which is utilized to be electrically connected with a host, a first storage medium interface which is utilized to be electrically connected with a first storage medium, and a second storage medium interface which is utilized to be electrically connected with a second storage medium; and copying data from the first storage medium to the second storage medium without passing through the host interface.

According to another embodiment of the present invention, a data backup apparatus comprises a first storage medium interface, a second storage medium interface, a trigger device, a storage device and a controller. The first storage medium interface is utilized to be electrically connected with a first storage medium, and the second storage medium interface is utilized to be electrically connected with a second storage medium. The storage device is utilized for storing a backup schedule. The controller is coupled to the first storage medium interface, the second storage medium interface, the trigger device and the storage device, and after receiving a trigger signal from the trigger device, the controller copies data from the first storage medium to the second storage medium according to the backup schedule.

According to the data backup apparatus and the data backup method of the present invention, the bandwidth between the host and the first/second storage medium will not be greatly occupied, and the loading of the host will not be increased. Therefore, the other operations of the host and the first/second storage medium will not be influenced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a data backup apparatus according to one embodiment of the present invention.

FIG. 2 is a diagram illustrating a flow chart of a data backup method according to one embodiment of the present invention.

FIG. 3 is a diagram illustrating a data backup apparatus according to another embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

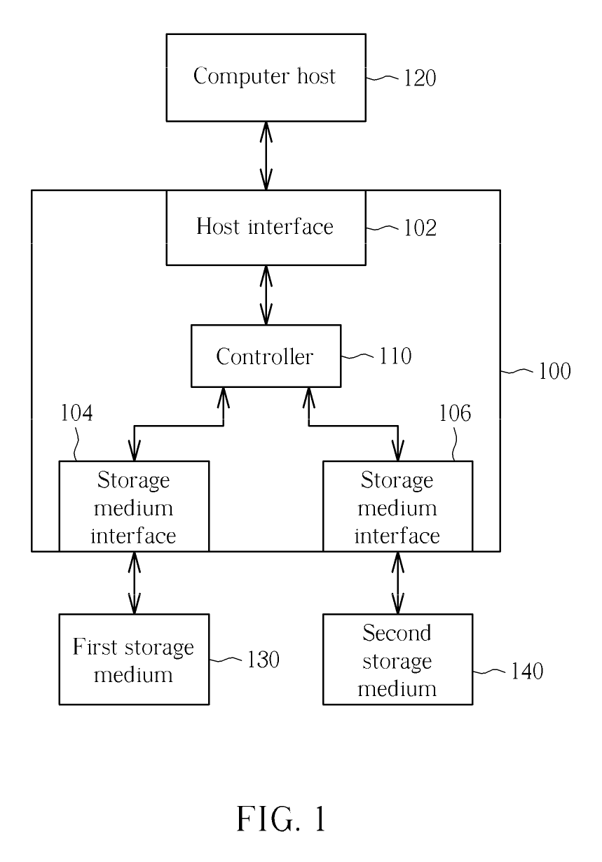

Please refer to FIG. 1. FIG. 1 is a diagram illustrating a data backup apparatus 100 according to one embodiment of the present invention. As shown in FIG. 1, the data backup apparatus 100 includes a host interface 102, two storage medium interfaces 104 and 106, and a controller 110, where the host interface 102 is electrically connected to a computer host, and the storage medium interfaces 104 and 106 are electrically connected to a first storage medium 130 and a second storage medium 140. The host interface 102 and the storage medium interfaces 104 and 106 can be SATA (Serial Advanced Technology Attachment) interfaces, IDE (Integrated Device Electronics) interfaces, USB (Universal Serial Bus) interfaces, or IEEE1394 interfaces. In addition, in this embodiment, the data backup apparatus 100 can be, but is not limited to, a portable HD (hard disk) backup apparatus (i.e., external to the computer host 120), and the first storage medium 130 and the second storage medium 140 are hard disks.

When a user intends to backup (copy) data from the first storage medium 130 to the second storage medium 140, the user first uses the computer host 120 to transmit a backup command to the controller 110, where the backup command includes a location of the data (i.e., the data needed to be backed up) in the first storage medium 130, a length information of the data in the first storage medium 130, a location of the second storage medium 140 where the data is to be written, and a length information of the data which is to be written to the second storage medium 140. Then, the controller 110 copies the data from the first storage medium 130 to the second storage medium 140 without passing through the host interface 102. In other words, the data from the first storage medium 130 passes through the storage medium interface 104, the controller 110, the storage medium interface 106, and is finally written into the second storage medium 140. Therefore, when the data is copied from the first storage medium 130 to the second storage medium 140, a bandwidth between computer host 120 and the data backup apparatus 100 will not be occupied, and can be used for other operations.

In addition, the controller 110 can determine how to backup the data in the first storage medium 130 according to statuses of the first and the second storage mediums 130 and 140. For example, if the first storage medium 130 and/or the second storage medium 140 are in busy states, the controller 110 can temporarily stop backing up data until the first storage medium 130 and/or the second storage medium 140 are in idle states.

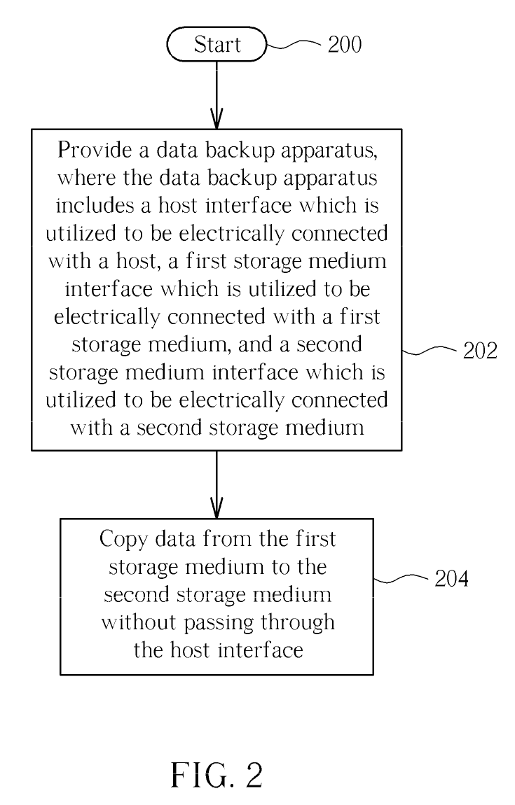

Please refer to FIG. 2. FIG. 2 is a diagram illustrating a flow chart of a data backup method according to one embodiment of the present invention. The flow shown in FIG. 2 corresponds to the data backup apparatus 100 shown in FIG. 1. The method is described as follows:

Step 200: Start.

Step 202: Provide a data backup apparatus 100, where the data backup apparatus 100 includes a host interface 102 which is utilized to be electrically connected with a host 120, a first storage medium interface 104 which is utilized to be electrically connected with a first storage medium 130, and a second storage medium interface 106 which is utilized to be electrically connected with a second storage medium 140.

Step 204: Copy data from the first storage medium 130 to the second storage medium 140 without passing through the host interface 102.

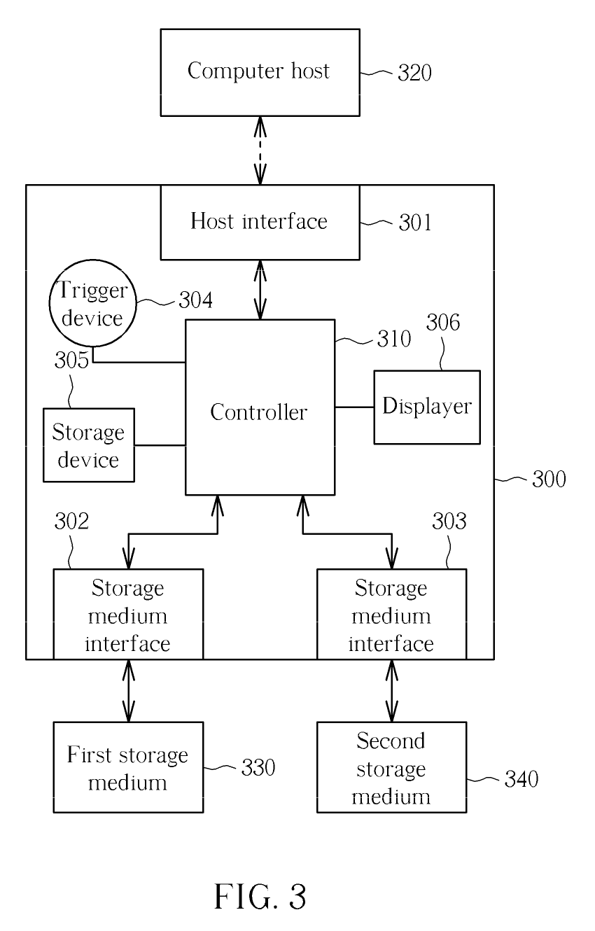

Please refer to FIG. 3. FIG. 3 is a diagram illustrating a data backup apparatus 300 according to another embodiment of the present invention. As shown in FIG. 3, the data backup apparatus 300 includes a host interface 301, two storage medium interfaces 302 and 303, a trigger device 304, a storage device 305, a displayer 306 and a controller 310, where the host interface 301 is electrically connected to a computer host 320, and the storage medium interfaces 302 and 303 are electrically connected to a first storage medium 330 and a second storage medium 340. The host interface 301 and the storage medium interfaces 302 and 303 can be SATA (Serial Advanced Technology Attachment) interfaces, IDE (Integrated Device Electronics) interfaces, USB (Universal Serial Bus) interfaces, or IEEE1394 interfaces. In addition, in this embodiment, the data backup apparatus 300 can be, but is not limited to, a portable HD (hard disk) backup apparatus (i.e., external to the computer host 320), the first storage medium 330 and the second storage medium 340 are hard disks, and the trigger device 304 can be a button.

In the operations of the data backup apparatus 300, a user first uses the computer host 320 to transmit a backup schedule to the controller 310, where the backup schedule includes a location of the data (i.e., the data needed to be backed up) in the first storage medium 330, a length information of the data in the first storage medium 330, a location of the second storage medium 340 where the data is to be written, and a length information of the data which is to be written to the second storage medium 340. Then, the controller 310 stores the backup schedule to the storage device 305. It is noted that the controller 310 does not begin backing up of the data in the first storage medium 330 at this time. After the backup schedule is stored into the storage device 305, the user can determine if the data backup apparatus 300 can be removed from the computer host 320 (i.e., the data backup apparatus 300 can be disconnected from the computer host 320. Then, when the user decides to copy the data from the first storage medium 330 to the second storage medium 340, the user uses the trigger device 304 to transmit a trigger signal for triggering the controller 310 to copy the data from the first storage medium 330 to the second storage medium 340 without passing through the host interface 301. In other words, the data from the first storage medium 330 passes through the storage medium interface 302, the controller 310, the storage medium interface 303, and is finally written into the second storage medium 340.

It is noted that, in the data backup apparatus 300, the backup schedule is generated from the computer host 320, and then transmitted to the controller, and finally stored into the storage device 305. n another embodiment of the present invention, however, the user can use the displayer 306 and the controller 310 to generate the backup schedule (i.e., the host interface 301 is an optional device and can be removed from the data backup apparatus 300). This alternative design also falls within the scope of the present invention.

Briefly summarized, in the data backup apparatus and the data backup method of the present invention, the data is copied from the first storage medium to the second storage medium without passing through the host interface. Therefore, the bandwidth between the host and the first/second storage mediums will not be greatly occupied, the loading of the host will not be increased, and therefore other operations of the host and the first/second storage medium will not be influenced.

Those skilled in the art will readily observe that numerous modifications and alterations of the device and method may be made while retaining the teachings of the invention.

What is claimed is:

1. A data backup apparatus, comprising:
a host interface, for being electrically connected with a host;
a first storage medium interface, for being electrically connected with a first storage medium;
a second storage medium interface, for being electrically connected with a second storage medium; and
a controller, coupled to the host interface, the first storage medium interface and the second storage medium interface, for copying data from the first storage medium to the second storage medium without passing through the host interface.

2. The data backup apparatus of claim 1, wherein the controller receives a backup command generated from the host, and copies the data from the first storage medium to the second storage medium according to the backup command.

3. The data backup apparatus of claim 2, wherein the backup command comprises a location of the data in the first storage medium, a length information of the data in the first storage medium, a location of the second storage medium where the data is to be written, and a length information of the data which is to be written to the second storage medium.

4. The data backup apparatus of claim 1, wherein the host interface, the first storage medium interface and the second storage medium interface can be SATA (Serial Advanced Technology Attachment) interfaces, IDE (Integrated Device Electronics) interfaces, USB (Universal Serial Bus) interfaces, or IEEE1394 interfaces.

5. The data backup apparatus of claim 1, being a portable data backup apparatus.

6. A data backup method, comprising:
providing a data backup apparatus, where the data backup apparatus comprises a host interface which is utilized to be electrically connected with a host, a first storage medium interface which is utilized to be electrically connected with a first storage medium, and a second storage medium interface which is utilized to be electrically connected with a second storage medium; and
copying data from the first storage medium to the second storage medium without passing through the host interface.

7. The data backup method of claim 6, wherein the step of copying the data from the first storage medium to the second storage medium comprises:
receiving a backup command generated from the host; and
copying the data from the first storage medium to the second storage medium according to the backup command.

8. The data backup method of claim 7, wherein the backup command comprises a location of the data in the first storage medium, a length information of the data in the first storage medium, a location of the second storage medium where the data is to be written, and a length information of the data which is to be written to the second storage medium.

9. The data backup method of claim 6, wherein the host interface, the first storage medium interface and the second storage medium interface can be SATA (Serial Advanced Technology Attachment) interfaces, IDE (Integrated Device Electronics) interfaces, USB (Universal Serial Bus) interfaces, or IEEE1394 interfaces.

10. The data backup method of claim 6, wherein the data backup apparatus is a portable data backup apparatus.

11. A data backup apparatus, comprising:
a first storage medium interface, for being electrically connected with a first storage medium;
a second storage medium interface, for being electrically connected with a second storage medium;
a trigger device;
a storage device, for storing a backup schedule; and
a controller, coupled to the first storage medium interface, the second storage medium interface, the trigger device and the storage device, wherein after receiving a trigger signal from the trigger device, the controller copies data from the first storage medium to the second storage medium according to the backup schedule.

12. The data backup apparatus of claim 11, further comprising:
a host interface, for being electrically connected with a host;
wherein the backup schedule is generated from the host, and is transmitted to the storage device via the host interface.

13. The data backup apparatus of claim 11, being a portable data backup apparatus.
